(19) United States
(12) Patent Application Publication
(10) Pub. No.: US 2025/0232463 A1
(43) Pub. Date: Jul. 17, 2025

(54) IMAGE PROCESSING APPARATUS, CONTROL METHOD OF IMAGE PROCESSING APPARATUS, AND NON-TRANSITORY COMPUTER-READABLE STORAGE MEDIUM

(71) Applicant: CANON KABUSHIKI KAISHA, Tokyo (JP)

(72) Inventor: Ryota SUZUKI, Tokyo (JP)

(21) Appl. No.: 19/006,354

(22) Filed: Dec. 31, 2024

(30) Foreign Application Priority Data
Jan. 11, 2024 (JP) 2024-002791

(51) Int. Cl. G06T 7/571; G06F 3/01

(52) U.S. Cl. CPC G06T 7/571; G06F 3/016

(57) ABSTRACT

An image processing apparatus which executes acquisition processing to acquire information on focus levels indicating degrees of focus of imaging objects included in image data to be processed, the information being obtained based on imaging information when image data as the processing target is acquired by imaging, executes haptics change processing to make, based on the information on the focus levels, a first change on haptics data acquired in association with the image data as the processing target, and executes generation processing to generate an image file by associating, with the image data as the processing target, the haptics data after the first change is performed, wherein the first change includes changing values of the haptics data of at least some imaging objects among the imaging objects.

### BACKGROUND OF THE DISCLOSURE

### Field of the Disclosure

The present invention relates to an image processing apparatus, a control method of an image processing apparatus, and a non-transitory computer-readable storage medium.

### Description of the Related Art

Recently, haptics technology for feeding back tactile information and temperature information (warm sensation and cold sensation information) and haptics devices for implementing the haptics technology have been developed. It is conceivable that in cooperation with a haptics acquisition sensor in the future, an imaging device such as a digital camera records image data acquired by an image sensor and haptics data acquired by the haptics acquisition sensor in association with each other. In content recorded in this manner, it is possible to feedback haptics data such as tactile sensation and warm sensation and cold sensation to a user simultaneously with reproduction of image data.

On the other hand, since the use of the haptics acquisition sensor is different from image acquisition use, it is conceivable that the haptics acquisition sensor is configured by a sensor different from the image sensor. In such a configuration, there is a possibility that visual information and haptics information deviate from each other. Therefore, it is desirable to eliminate a sense of incongruity caused by an information deviation between the visual information and the haptics information.

Japanese Patent Laid-Open No. 2016-110383 discloses a method of recording visual information, tactile information, locus information on a tactile sensor, and position information in association with one another, and performing tactile presentation synchronized with a visual position based on information such as a position, a moving direction, and a speed of touching a reproduction device at the time of reproduction.

### SUMMARY OF THE DISCLOSURE

The above-described known technology cannot cope with information deviation between visual information and haptics information caused by imaging conditions such as distinguishing an in-focus area and an out-of-focus area.

Therefore, a technology of suppressing information deviation between visual information and haptics information is provided.

One aspect of embodiments relates to an image processing apparatus comprising, one or more processors and a memory storing a program which, when executed by the one or more processors, causes the image capture apparatus to execute acquisition processing to acquire information on focus levels indicating degrees of focus of imaging objects included in image data to be processed, the information being obtained based on imaging information when image data as the processing target is acquired by imaging, execute haptics change processing to make, based on the information on the focus levels, a first change on haptics data acquired in association with the image data as the processing target, and execute generation processing to generate an image file by associating, with the image data as the processing target, the haptics data after the first change is performed, wherein the first change includes changing values of the haptics data of at least some imaging objects among the imaging objects.

Further features of the present disclosure will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the disclosure, and together with the description, serve to explain the principles of the disclosure.

FIG. 1A is a view illustrating an example of a hardware configuration of an image processing system 10 in a first embodiment.

FIG. 1B is a view illustrating an example of a functional configuration of the image processing system 10 in the first embodiment.

FIG. 2A is a view illustrating an example of image data acquired in the first embodiment.

FIG. 2B is a view illustrating an example of a configuration of haptics data acquired in the first embodiment.

FIG. 2C is a view illustrating an example of a data format in the first embodiment.

FIG. 3A is a view illustrating an example of image data in the first embodiment.

FIG. 3B is a view illustrating a configuration example of focus level information in the first embodiment.

FIG. 3C is a view illustrating an example of a format of the focus level information in the first embodiment.

FIG. 4A is a view illustrating an example of the focus level information in the first embodiment.

FIG. 4B is a view illustrating an example of gain assignment in an in-focus area in the first embodiment.

FIG. 5 is a flowchart showing an example of processing in the first embodiment.

FIG. 6 is a view for describing an example of a setting method of the in-focus area in the first embodiment.

FIG. 7 is a view for describing a conversion method of haptics data in the first embodiment.

FIG. 8A is a view illustrating an example of processing target image data in a second embodiment.

FIG. 8B is a view illustrating an example of an arrangement relationship of each subject with respect to an imaging apparatus in the second embodiment.

FIG. 8C is a view illustrating an example of haptics data in the second embodiment.

FIG. 9 is a view illustrating an example of a functional configuration of an image processing system in the second embodiment.

FIG. 10 is a view illustrating an example of edge information on image data and haptics data in the second embodiment.

FIG. 11 is a flowchart showing an example of processing in the second embodiment.

FIG. 12 is a view illustrating an example of a functional configuration of an image processing system in a third embodiment.

FIG. 13 is a view illustrating an example of a functional configuration of an image processing system in a fourth embodiment.

FIG. 14 is a flowchart showing an example of processing in the fourth embodiment.

FIG. 15A is a view illustrating an example of a configuration of a depth map in the fourth embodiment.

FIG. 15B is a view illustrating an example of focus level information in the fourth embodiment.

FIG. 15C is a view illustrating an example of a data format in the fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

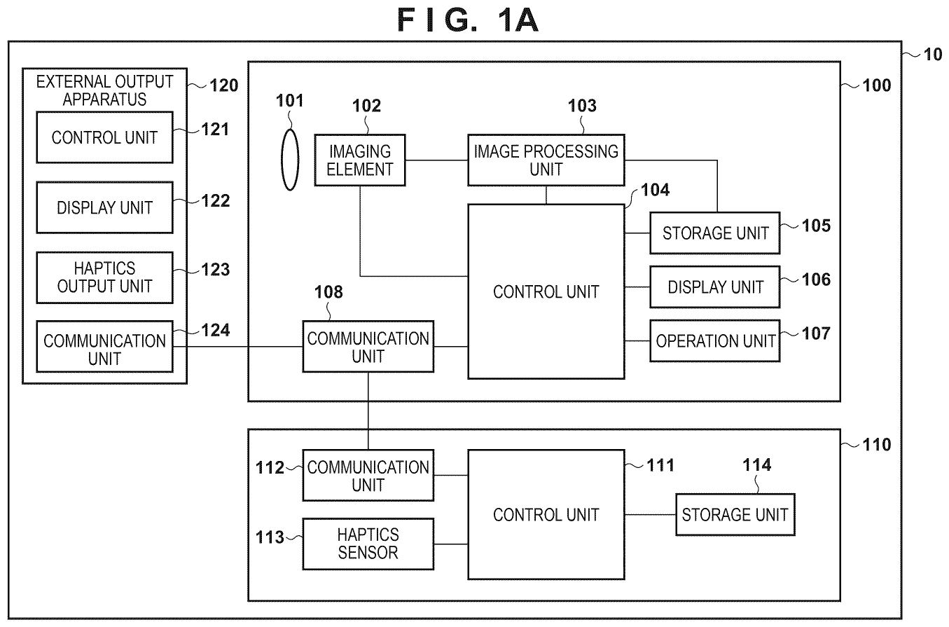

First, a configuration example of an image processing system corresponding to the present embodiment will be described. FIG. 1A is a block diagram illustrating an example of the hardware configuration of the image processing system 10 corresponding to an example of the present embodiment. The image processing system 10 can be configured by connecting an imaging apparatus 100, a haptics acquisition apparatus 110, and an external output apparatus 120.

In FIG. 1A, the imaging apparatus 100 can include a lens optical system 101, an imaging element 102, an image processing unit 103, a control unit 104, a storage unit 105, a display unit 106, an operation unit 107, and a communication unit 108. These components are merely examples, and the imaging apparatus 100 may include components other than the components illustrated in FIG. 1A.

The lens optical system 101 condenses light from a subject on the imaging element 102 by an optical lens, an aperture, and focus control. The imaging element 102 is, for example, a CMOS imaging sensor, photoelectrically converts light incident through the lens optical system 101, and outputs the light as an image signal. The image processing unit 103 performs various types of correction such as filter processing, digital image processing such as compression, and the like on the image signal output from the imaging element 102. The control unit 104 controls drive timing of the imaging element 102, and integrally drives and controls the entire imaging apparatus such as the image processing unit 103, the display unit 106, and the communication unit 108. The control unit 104 includes, for example, a CPU, a ROM, and a RAM, and can perform overall operation control of the apparatus by the CPU developing a program stored in the ROM in a work area of the RAM and executing the program.

The image processing unit 103 acquires imaging information when the imaging apparatus 100 performs imaging. The imaging information includes information unique to the imaging apparatus and information unique to a photographed image. Examples of the information unique to the imaging apparatus include the size of a sensor or a permissible confusion circle diameter, and the brightness of the optical system or a focal length. Examples of the information unique to the photographed image include an aperture value, an in-focus distance, a Bv value, a RAW image, an exposure time, a gain (ISO sensitivity), a white balance coefficient, distance information, position information by a GPS or the like, and time information such as date and time. In addition, examples of the information unique to the photographed image include a gravity sensor value, acceleration, a geomagnetic direction, temperature, humidity, atmospheric pressure, or altitude at the time of imaging.

The storage unit 105 is a storage medium such as a nonvolatile memory or a memory card that stores and holds image signals output from the image processing unit 103. The storage unit 105 may be configured to be mountable with an external storage medium (such as a memory card), and can take in haptics data stored in the external storage medium. The display unit 106 is a display that displays a photographed image, various setting screens, and the like. The operation unit 107 includes a button, a touch panel, and a switch, receives an operation input from a user, and reflects a command of the user on the control unit 104.

The communication unit 108 communicates with the haptics acquisition apparatus 110 and the external output apparatus 120 under the control of the control unit 104. The communication unit 108 receives haptics data from the haptics acquisition apparatus 110 and provides the haptics data to the control unit 104. The apparatuses connected to the imaging apparatus 100 can be connected in a wired manner via a USB connection method, for example. The wired connection method is not limited to the USB, and may be any connection method. The connection is not limited to the wired communication method, and may be made by a wireless communication method (e.g., IEEE 802.11x, NFC, and the like).

The haptics acquisition apparatus 110 can include a control unit 111, a communication unit 112, a haptics sensor 113, and a storage unit 114. These components are merely examples, and the imaging apparatus 100 may include components other than the components illustrated in FIG. 1A.

The control unit 111 controls drive timing of the haptics sensor 113 and integrally drives and controls the entire apparatuses such as the communication unit 112 and the storage unit 114. For example, when a signal notifying shutter timing of still image imaging in the imaging apparatus 100 is received from the imaging apparatus 100, haptics data can be acquired in response to the notification signal. In the case of moving image imaging, a haptics acquisition command is periodically transmitted from the imaging apparatus 100, and haptics data can be acquired in response to reception of the command. Since at least information on acquisition time can be included in the acquired haptics data as attribute information, it is possible to specify at which timing of the moving image the haptics data is acquired based on time information.

The haptics sensor 113 can be configured by, for example, a thermosensor or a tactile sensor, and can acquire an electrical signal indicating haptics information such as temperature or tactile information on a target object. The electrical signal obtained by the haptics sensor 113 is converted into a digital signal and provided to the control unit 111 as haptics data. The acquired haptics data can include attribute information such as information regarding the acquisition time and position information. While FIG. 1A illustrates only one haptics sensor 113, a plurality of types of haptics sensors may be included. Even in such a case, the haptics data is acquired in the haptics sensor 113 in synchronization with imaging of the image.

The communication unit 112 communicates with the imaging apparatus 100 under the control of the control unit 111, and transmits, to the imaging apparatus 100, haptics data acquired by the haptics sensor 113. The communication unit 112 performs communication by, for example, the USB in a case of the wired connection method, and performs communication by, for example, IEEE 802.11x or NFC in a case of the wireless connection method.

The storage unit 114 can store haptics data acquired by the haptics sensor 113. The stored haptics data may be read from the control unit 111 and provided to the imaging apparatus 100 via the communication unit 112. The storage unit 114 may be configured to be mountable with an external storage medium (memory card or the like), and haptics data stored in the external storage medium may be provided to the imaging apparatus 100 by being removed from the haptics acquisition apparatus 110 and mounted to the imaging apparatus 100.

The external output apparatus 120 can include a control unit 121, a display unit 122, a haptics output unit 123, and a communication unit 124. These components are merely examples, and the imaging apparatus 100 may include components other than the components illustrated in FIG. 1A.

The control unit 111 performs operation control of the external output apparatus 120. An image file received via the communication unit 124 is separated into image data for display and haptics data for haptics output, and is supplied to the display unit 122 and the haptics output unit 123, thereby controlling the respective operations. When a touch input is performed via the display unit 122, the touch input can be detected and a request from the user can be received. The request can be transmitted to the imaging apparatus 100 side via the communication unit 124.

The display unit 122 is configured to be able to display image data and also able to perform touch sensing, and can receive a touch input instruction by the user. The haptics output unit 123 can perform tactile output on a display surface. Some functions of the haptics output unit 123 and the display unit 122 may be integrally configured as a display.

The haptics output unit 123 may be configured to include a wearable device that can be worn by the user. The wearable device may be, for example, a glove that can be worn by the user on the hand, and the user can perform operation input on the display with the glove being worn. The glove is connected to the external output apparatus 120 by near field wireless communication, and can be configured such that temperature data and tactile data are transmitted to the glove in accordance with operation input content, and an output in accordance with the position touched by the user can be sensed by the user via the glove.

The communication unit 124 communicates with the imaging apparatus 100 under the control of the control unit 121. An image file can be received from the imaging apparatus 100, and user input information received by the display unit 122 can be transmitted to the imaging apparatus 100. The communication unit 124 performs communication by, for example, the USB in a case of the wired connection method, and performs communication by, for example, IEEE 802.11x or NFC in a case of the wireless connection method.

Next, the functional configuration of the image processing system 10 corresponding to the first embodiment will be described with reference to FIG. 1B. The image processing system 10 can generate and record an image file by associating image data with haptics data. The image data includes still images and moving images, and the haptics data includes, for example, tactile data and temperature data. In the present embodiment, with temperature data acquired using a thermosensor (temperature sensor) as an example of haptics data, and a case where an image file is generated and recorded in association with haptics data when recording one still image will be described. Note that also in a case of a moving image, in the relationship between a moving image frame and haptics data corresponding to haptics data acquisition timing, a relationship similar to that between a still image and haptics data is established, and therefore processing can be performed similarly to the following description.

As illustrated in FIG. 1B, the image processing system 10 has a functional configuration of, for example, an image acquisition unit 151, a focus level information calculation unit 152, a haptics acquisition unit 153, a haptics change unit 154, a recording processing unit 155, and a storage medium 156.

The image acquisition unit 151 mainly includes the lens optical system 101, the imaging element 102, and the image processing unit 103, and converts optical information from the lens optical system 101 into an electrical signal in the imaging element 102 and outputs the electrical signal. The image acquisition unit 151 outputs, to the focus level information calculation unit 152 and the recording processing unit 155, image data in which an electrical signal obtained by the sensor is converted into a digital signal.

The image acquisition unit 151 outputs imaging information at the time of acquiring the image data to the focus level information calculation unit 152. The imaging information includes, for example, sensor diameter information, aperture value (F number) information, and focal length (f) information. Based on the image data and the imaging information input from the image acquisition unit 151, the focus level information calculation unit 152 calculates and provides, to the haptics change unit 154, a focus level indicating a degree of focus for each imaging object included in the image data. The focus level information and a calculation method thereof will be described later. The focus level information calculation unit 152 is implemented by the control unit 104.

Next, the haptics acquisition unit 153 is implemented by the haptics acquisition apparatus 110, and the haptics change unit 154 is implemented by the control unit 104. The haptics acquisition unit 153 outputs the temperature data obtained from the haptics sensor to the haptics change unit 154.

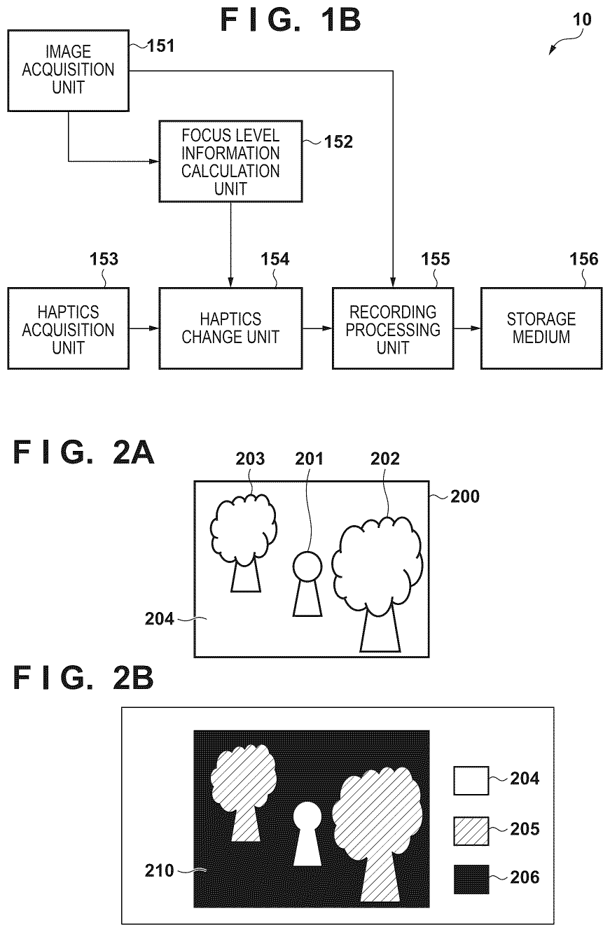

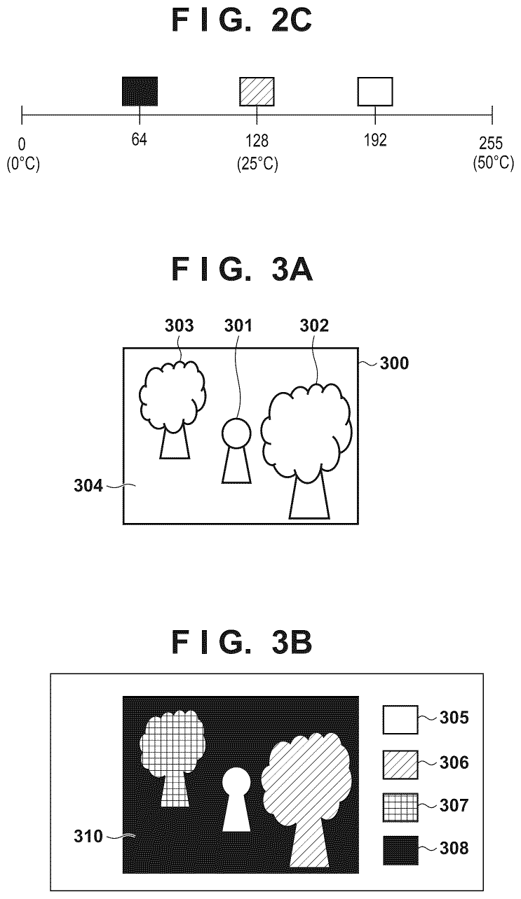

Here, a configuration example of haptics data will be described with reference to FIG. 2. FIG. 2A illustrates an example of image data 200 acquired by the image acquisition unit 151. The image data 200 as a processing target in the present embodiment includes a plurality of imaging objects. The imaging objects include any objects such as a person, an animal, an automobile, a plant, a tree, and a background, and these can be largely distinguished into a subject and a background. FIG. 2A illustrates a case of including a subject 201, a subject 202, a subject 203, and a background 204. FIG. 2B illustrates an example of haptics data 210 acquired in association with the image data 200 illustrated in FIG. 2A. The haptics data 210 has a correspondence relationship with the image data 200 in predetermined units (e.g., in units of pixels, or in units of blocks or regions). The description of the present embodiment assumes that the haptics data 210 is two-dimensionally configured so as to match or correspond to the number of pixels in the horizontal and vertical directions of the image data 200, and each pixel is associated with one value.

In FIG. 2B, the values of haptics data 210 are associated with the subject 201, the subject 202, the subject 203, and the background 204 included in the image data 200 of FIG. 2A. The temperatures of the respective imaging objects correspond to the colors or patterns indicated by reference numbers 204 to 206, respectively. Specifically, the temperature information of the subject 201 is recorded at a coordinate position corresponding to the subject 201 in the image data 200 of FIG. 2A as a white region indicated by reference number 204. Similarly, the temperature information on the subject 202 and the subject 203 are indicated by hatching with reference number 205, and the temperature information on the background 204 is indicated by black with reference number 206. The respective pieces of temperature information are recorded at the same coordinate positions as the subjects 202 and 203 and the background 204 in the image data 200.

In the present embodiment, similarly to the image data 200, the haptics data 210 can be digital data expressed by a predetermined tone number. An example of a data format corresponding to the present embodiment is illustrated in FIG. 2C. FIG. 2C illustrates an example in which the haptics data 210 is expressed in temperature with 256 tones by 8 bits. A temperature is assigned for each haptics data value of 0 to 255. Due to this, for example, when any of the display regions is selected by the user in a state where the image data 200 is displayed on the display unit 106 of the imaging apparatus 100 or the display unit 122 of the external output apparatus 120, the temperature to be fed back can be determined in accordance with the value of the haptics data 210 of the selected region. FIG. 2C illustrates an example in which the haptics data 210 is assigned with 0° C. when the value is 0 and 50° C. when the value is 255. In FIG. 2C, the temperature of the subject 201 corresponds to the tone number of 192, and is thus 37.5° C. The temperature of the subjects 202 and 203 corresponds to the tone number of 128, and is thus 25° C. Since the temperature of the background 204 corresponds to the tone number of 64, and is thus 12.5° C.

Although the haptics data 210 is expressed with 256 tones in the present embodiment, the haptics data 210 is not limited to this tone number and can be expressed with any tone number. The configuration of the haptics data is not limited to the above, and may be in compliance with a standard designated by the manufacturer of the imaging apparatus 100 or the haptics acquisition apparatus 110, or a common standard established by a standard organization such as MPEG may be used.

The haptics change unit 154 is implemented by the control unit 104, and changes haptics data input from the haptics acquisition unit 153 by using the focus level information input from the focus level information calculation unit 152. Then, the haptics data after the change is output to the recording processing unit 155. Details of the change of the haptics data will be described later.

The recording processing unit 155 is implemented by the control unit 104, and multiplexes the image data input from the image acquisition unit 151 and the haptics data input from the haptics change unit 154 into one file to generate an image file including the haptics data, and saves the image file in the storage medium 156. The storage medium 156 is implemented by the storage unit 105, and holds the image file including the haptics data output by the recording processing unit 155.

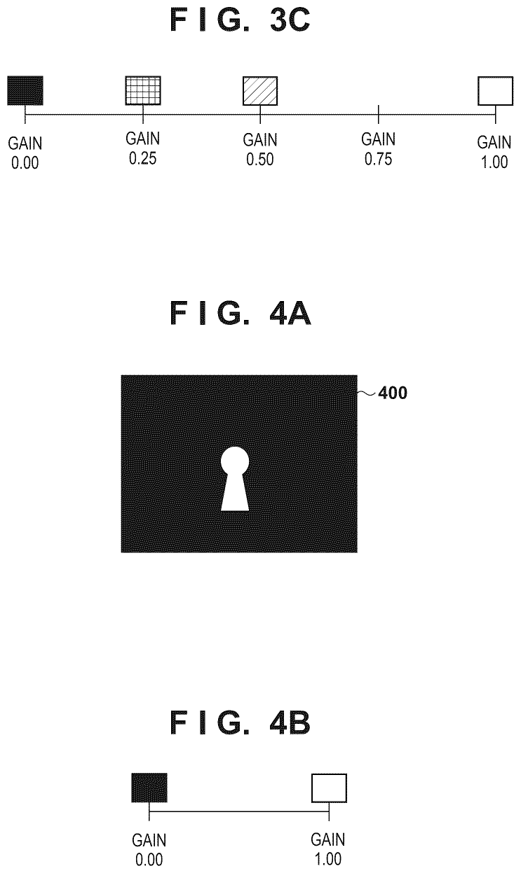

Next, a configuration example of the focus level information will be described with reference to FIG. 3. FIG. 3A illustrates an example of image data 300 acquired by the image acquisition unit 151, and includes a subject 301, a subject 302, a subject 303, and a background 304. FIG. 3B illustrates an example of focus level information 310 in which the degree of focus of the image data 300 illustrated in FIG. 3A is colored. The focus level information 310 has a correspondence relationship with the image in units of predetermined regions. The description of the present embodiment assumes that the focus level information 310 is two-dimensionally configured so as to match the number of pixels in the horizontal and vertical directions of the image data 300, and each pixel is associated with one focus level value.

In FIG. 3B, the values of the focus levels of the subject 301, the subject 302, the subject 303, and the background 304 correspond to the colors or patterns indicated by reference numbers 305 to 308, respectively. Specifically, the focus level information of the subject 301 is recorded at a coordinate position corresponding to the subject 301 in the image data 300 as a white region indicated by reference number 305. Similarly, the focus level information on the subject 302 is indicated by hatching with reference number 306, the focus level information on the subject 303 is indicated by hatching with reference number 307, and the focus level information on the background 304 is indicated by black with reference number 308. Respective pieces of focus level information are recorded at coordinate positions corresponding to the subject 302, the subject 303, and the background 304, respectively, in the image data 300.

An example of a format of the focus level information in the present embodiment is illustrated in FIG. 3C. The focus level information is expressed by a numerical value of 0.0 to 1.0 as a gain value used for conversion processing of haptics data described later. The higher the focus level is and the more the region is in focus, the larger the gain value is. The lower the focus level is and the more the region is out of focus, the smaller the gain value is.

Although FIG. 3B illustrates an example of focus level information having four tones indicated by reference numbers 305 to 308, the tone number is not limited to this, and can be expressed by an arbitrary tone number and may be more than four tones. On the other hand, for example, if the in-focus area and the out-of-focus area are to be distinguished, they can be expressed by two tones as illustrated in FIG. 4. In in-focus information 400 illustrated in FIG. 4A, the white region represents an in-focus area, and the black region represents an out-of-focus area. As illustrated in FIG. 4B, the in-focus area in white is assigned with gain 1.0, and the out-of-focus area in black is assigned with gain 0.0.

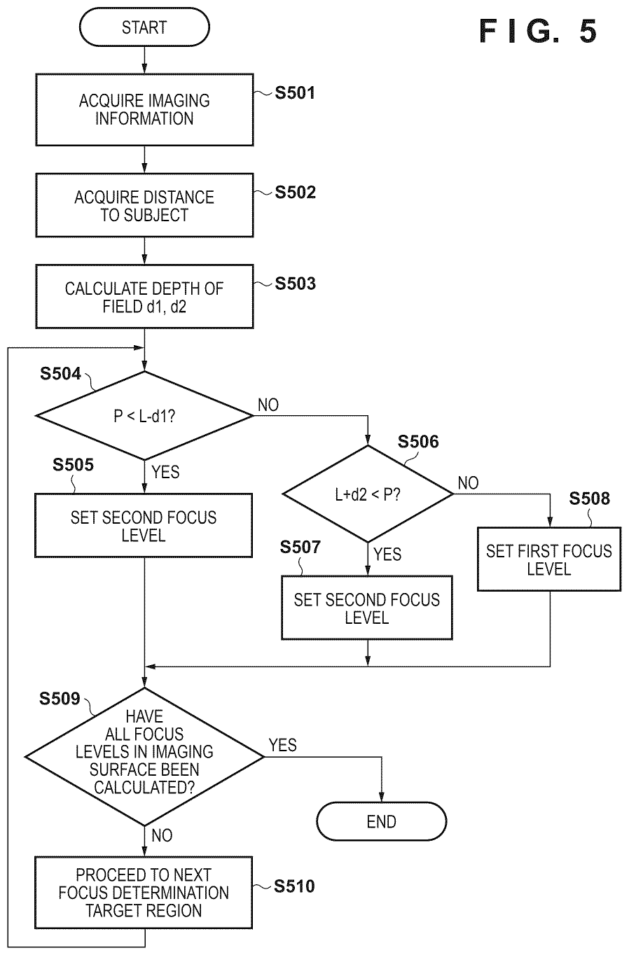

Next, an example of processing in the present embodiment will be described with reference to the flowchart of FIG. 5. The processing corresponding to the flowchart can be implemented, for example, by the CPU of the control unit 104 functioning as the focus level information calculation unit 152 executing a corresponding program (stored in the ROM or the like). In the following description, a case where the focus level as illustrated in FIG. 4 is assigned to a binary value will be described.

First, in S501, the focus level information calculation unit 152 acquires imaging information from the image acquisition unit 151. The imaging information includes, for example, a sensor diameter, an F number, and a focal length f. The focus level information calculation unit 152 also determines a permissible confusion circle based on the sensor diameter information. The permissible confusion circle may be determined as a fixed statistical value in accordance with the sensor diameter or may be determined as a cell pitch of the sensor, or information included in the imaging information may be used as the information on the permissible confusion circle.

In subsequent S502, the focus level information calculation unit 152 acquires a distance L to the imaging object obtained by the image acquisition unit 151 using a distance measurement technology such as an autofocus function. The imaging object for which the distance L is calculated may be a subject positioned in the in-focus area in the autofocus function, or may be selected by the user in a case where a plurality of subjects are included. In subsequent S503, the focus level information calculation unit 152 calculates a depth of field based on the information obtained in S501 and S502. Specifically, a front depth of field d1 and a rear depth of field d2 are calculated in accordance with the following Expression (1) and (2).

$$d 1 = δ F {L}^{∧} 2 / ( {f}^{∧} 2 + δ FL ) \qquad Expression ( 1 )$$

$$d 2 = δ F {L}^{∧} 2 / ( {f}^{∧} 2 - δ FL ) \qquad Expression ( 2 )$$

δ: permissible confusion circle, F: F number, L: distance to subject, f: focal length

In processing in and after subsequent step S504, the focus level information calculation unit 152 determines the focus level of each imaging object included in the image data based on whether each imaging object is included in the in-focus area set based on the subject of the imaging object positioned at the distance L (alternatively, which one of the in-focus area and the out-of-focus area each imaging object is included).

Specifically, in S504, the positional relationship among a distance P from the imaging apparatus 100 to an arbitrary region (focus determination target region) that is a target of focus determination, the distance L from the imaging apparatus 100 to the subject, and the front depth of field d1 is determined. Here, the subject at the distance L is assumed to be the subject 201 in the case of the image data 200 in FIG. 2A. The focus determination target region is set as a region having a predetermined size based on the coordinate position of the image data. The size of the region is arbitrary. The distance P can be measured using the autofocus function for each focus determination target region.

In the present processing, the focus level in the focus determination target region is determined with reference to the subject 201. When the distance P to the selected focus determination target region satisfies P<L−d1, the process proceeds to S505. On the other hand, when the distance P does not satisfy P<L−d1, the process proceeds to S506. In S505, the focus level information calculation unit 152 sets the focus determination target region to the second focus level. The focus determination target region is out of the in-focus area because it is too close to the imaging apparatus 100 side. The second focus level is a focus level set as an out-of-focus area, and a value less than 1.0 is set as the gain value. In the present embodiment, the gain value for the second focus level is assumed to be 0.

Next, in S506, the focus level information calculation unit 152 further determines the positional relationship of the focus determination target region based on the distance P, the distance L to the subject, and the rear depth of field d2. When the distance P satisfies L+d2<P, the process proceeds to S507. When L+d2<P is not satisfied, the process proceeds to S508.

In S507, the focus level information calculation unit 152 sets the focus level of the selected focus determination target region to the second focus level. The focus determination target region is out of the in-focus area because it is too far from the imaging apparatus 100. The processing in S507 is the same as the processing in S505. In S508, the focus level information calculation unit 152 sets the focus level of the selected focus determination target region to the first focus level. Since the first focus level is the focus level set as the in-focus area, 1.0 is set as the gain value.

In subsequent S509, the focus level information calculation unit 152 determines whether the focus levels have been set for all the focus determination target regions included in an imaging surface. When it is determined that the setting of the focus levels has been completed for all the focus determination target regions, the present processing ends. On the other hand, when there is an unprocessed focus determination target region, the process proceeds to S510. In S510, the focus level information calculation unit 152 selects the next focus determination target region, returns to S504, and repeats the above processing.

In the flowchart of FIG. 5, the gain value when set to the second focus level is 0, but the setting example of the gain value is not limited to this, and for example, the gain value may be not 0 but 0.5 or the like for a subject that belongs to an out-of-focus area on a side (front side) closer to the imaging apparatus 100 than the subject with the distance L. Conversely, the gain value may be not 0 but 0.5 or the like for a subject that belongs to the out-of-focus area on a side (rear side) farther from the imaging apparatus 100 than the subject with the distance L. This enables the relative positional relationship of the subject to be notified by haptics data other than the visual information on the image.

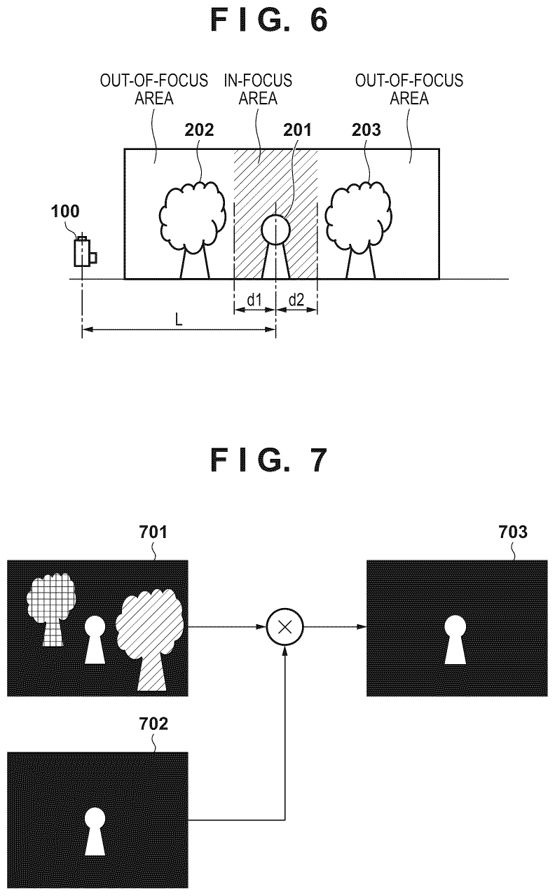

Here, an example of a setting method of an in-focus area with reference to the subject 201 will be described with reference to FIG. 6. FIG. 6 illustrates a positional relationship between the imaging apparatus 100 and the subject 201 or the like when the image data 200 is photographed. In FIG. 6, the imaging apparatus 100 captures images of a space in which the subject 202, the subject 201, and the subject 203 are arranged in this order from a side closer to the imaging apparatus 100. At this time, let the distance between the imaging apparatus 100 and the subject 201 be L. In the present embodiment, the focus determination is performed for each region including the subjects 202 and 203. Among them, a range from L−d1 to L+d2 with reference to the position of the subject 201 is recognized as an in-focus area, and the other regions are recognized as out-of-focus areas. In the case of the image data 200, since the subject 202 and the subject 203 are not positioned in the in-focus area, they are determined to be in the out-of-focus area.

In the flowchart of FIG. 5, the case where the focus level is expressed by a binary value has been described as an example. The focus level may be expressed by more values than a binary value. In this case, the determination condition of the distance P of the focus determination target region may be further increased. For example, although FIGS. 5 and 6 assume only the front depth of field d1 and the rear depth of field d2, the front depth of field d1 and the rear depth of field d2 may be subdivided. In this case, the determination conditions can be increased by equally dividing d1 and d2 into, for example, two and three, respectively. When the determination condition is increased in this manner, a larger value can be assigned as a gain value to an in-focus area closer to the subject 201 in focus. For example, in a case where d is divided into d11 and d12, and d2 is divided into d21 and d22, the gain value is 1.0 in a case of belonging to ranges of d11 and d21 closer to the subject of the distance L, and the gain value can be assigned with a value less than 1.0 (e.g., 0.5) in a case of belonging to ranges of d12 and d22 farther from the subject of the distance L.

Next, an example of a change method of haptics data performed by the haptics change unit 154 will be described with reference to FIG. 7. The change processing of haptics data in the present embodiment is hereinafter called “first change processing”. FIG. 7 illustrates an example in which haptics data 701 and focus level information 702 are multiplied. The haptics data 701 is haptics data before changed. The haptics data 701 and the focus level information 702 have the same number of data in the horizontal and vertical directions, and the gain value of the focus level can be applied to each value of the haptics data 701 by multiplying the data at the corresponding positions. The focus level information 702 uses an example expressed by the binary value illustrated in FIG. 4. In the change processing of haptics data, multiplication processing is performed on the haptics data 701 and the focus level information 702 in data units or arbitrary data block units.

In the first change processing of the haptics data, the value (amplitude value) of the haptics data remains as it is because the region with a high focus level has a large gain value. On the other hand, in a region with a low focus level, the value of haptics data is attenuated or becomes zero because the gain value is small. This can suppress information deviation between the visual information and the haptics information, such as the presence of haptics in an out-of-focus area. The above-described processing is repeatedly executed for the haptics data as the processing target.

Since the gain value of the focus level information described above has the lower limit of 0.0 and the upper limit of 1.0, the haptics data after the change remains as it is or the amplitude is attenuated. The upper limit and the lower limit of the gain value are not limited to the numerical values described in the present embodiment, and may be other values. For example, when the lower limit of the gain value is set to 1.0 and the upper limit thereof is set to 2.0, such haptics change is possible, in which the amplitude of haptics is amplified in a region with a higher focus level.

In addition, as for setting of the gain value, the value of the haptics data of the subject with the second focus level can be set to be attenuated, the value of the haptics data of the subject with the first focus level can be set to be larger than the value of the haptics data of the subject with the second focus level, or the degree of an increase in the value of the haptics data of the subject with the first focus level can be set to be larger than the degree of an increase in the haptics data of the subject with the second focus level.

According to the present embodiment, haptics data can be changed in accordance with the focus level of image data. Specifically, by setting a gain value corresponding to the focus level for each imaging object included in the image data and applying the gain value to the haptics data corresponding to the imaging object, it is possible to change individual values of the haptics data to values corresponding to the focus level. Due to this, the haptics data is attenuated or erased regarding imaging objects (out-of-focus subject and background) having low focus levels. Therefore, when image data is reproduced, haptics data is no longer provided to an imaging object other than a subject in focus, and therefore it is possible to reduce a sense of incongruity given to the user at the time of image reproduction.

Note that in the above-described embodiment, the gain value is set depending on whether the subject is positioned in an in-focus area, but for example, the gain value may be set with reference to the type of the subject. For example, it is assumed a case where the type such as a person, an animal (dog, cat, or bird), a car, a motorcycle, a bicycle, a train, an airplane, or the like can be detected as a subject by the autofocus function. In this case, when any subject is detected, the type information on the subject is included in imaging information as attribute information together with coordinate information in the image data. Due to this, even in a case where the subject is imaged out of an in-focus area, it is possible to perform adjustment so that the value remains in the haptics data for the subject of a predetermined type. For example, in the above-described embodiment, the gain value is 0 in a case where the subject is positioned in an out-of-focus area. However, the gain value is changed from 0 to 0.5 in a case where the subject is a predetermined type of subject, whereby the value can be caused to remain in the haptics data in a state where the gain value is lower than that of the subject positioned in an in-focus area but not completely attenuated.

### Second Embodiment

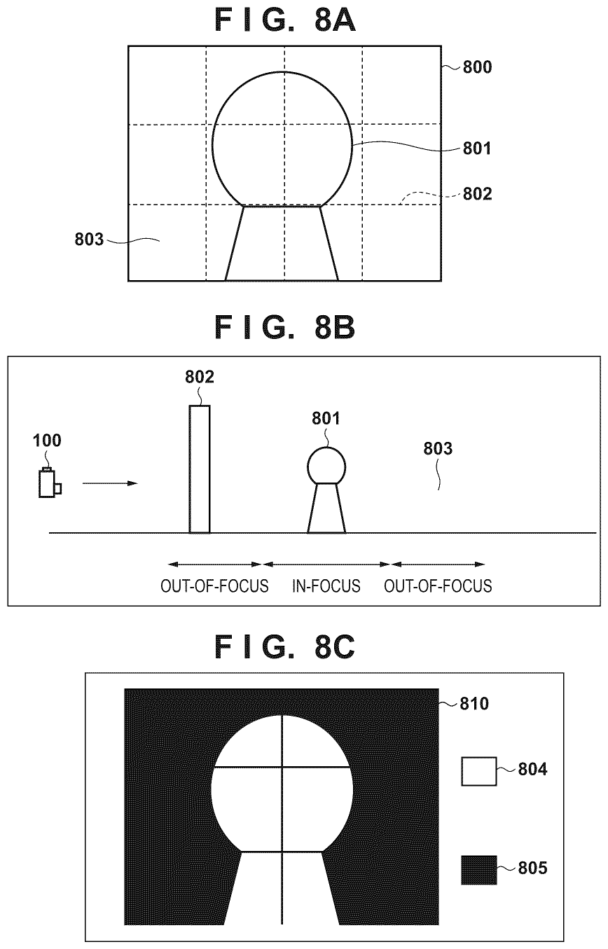

In the first embodiment, the method of changing haptics data in accordance with the focus level of image data has been described. However, there is a case where haptics data desired by the user cannot be obtained when there is an obstacle in the foreground or in front of the subject. For example, there can be a case where haptics data of a main subject does not exist or haptics data of another subject exists even in an image region in which the main subject is in focus as visual information obtained from the image data. In such a case, a deviation occurs between the visual information obtained from the image data and the haptics information to be output, and the user is given a sense of incongruity. Hereinafter, first, a case assumed as a problem in the present embodiment will be described with reference to FIG. 8. In the present embodiment, description of content similar to that of the first embodiment will be omitted.

FIG. 8A illustrates image data 800 as a processing target corresponding to the present embodiment. The image data 800 includes a main subject 801, a subject 802, and a background 803 as imaging objects. In the image data 800, the outline of the subject 801 indicated by a solid line indicates that the subject 801 is in focus. The outline of the subject 802 is indicated by a dotted line, which expresses that the subject 802 is out of focus in this case.

An arrangement relationship of each subject included in this image data 800 with respect to the imaging apparatus 100 is as illustrated in FIG. 8B. In this scene, the subject 802 is disposed as a front obstacle of the main subject 801. However, since the subject 802 is intentionally blurred and imaged using foreground blurring, it is assumed that the subject 802 in the image data 800 cannot be visually recognized by the user.

Regarding this scene, when haptics data is acquired similarly to the first embodiment and the value is changed in accordance with the focus level of the subject, haptics data of parts of the subject 802 having low focus levels is attenuated or erased. FIG. 8C illustrates an example of the haptics data assumed to be acquired at this time.

In FIG. 8C, haptics data 810 includes a part indicated as a region of white 804 associated with the main subject 801, and a region indicated by black 805 whose value is attenuated or erased by the first change processing described in the first embodiment. Since the haptics area associated with the subject 802 is an out-of-focus area, the haptics region is masked to zero by the first change processing. As a result, the haptics data corresponding to the main subject 801 indicated by the white 804 includes data lacking in a region where the main subject 801 and the subject 802 overlap.

Thus, in imaging using foreground blurring, it is not possible to visually recognize that there is an obstacle in front of the main subject from the image data obtained by the imaging. Therefore, when the haptics data is erased, an information deviation occurs between the image data and the haptics data. Therefore, in the present embodiment, a recovery method of haptics data in a case where a part of haptics data of a main subject is lacking due to a foreground or an obstacle will be described.

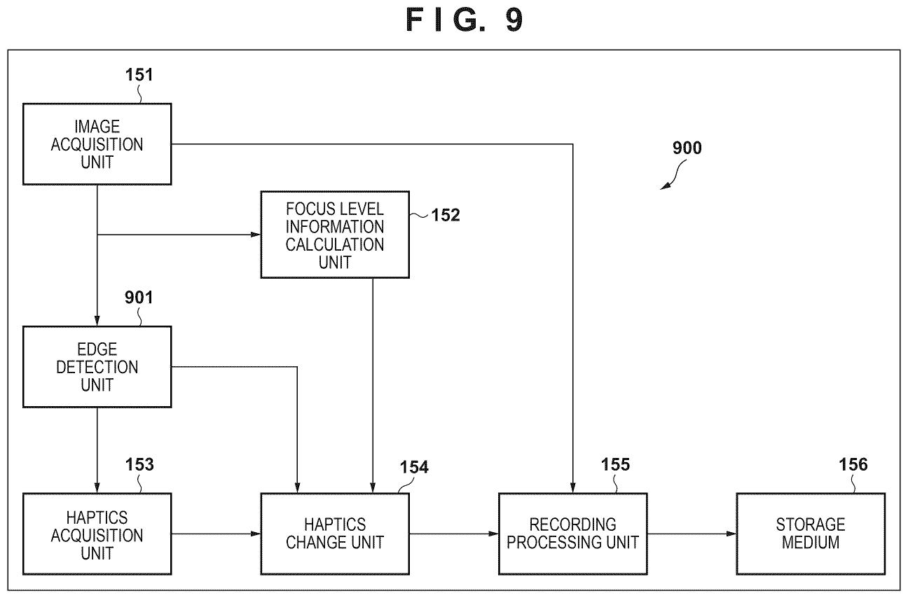

FIG. 9 illustrates an example of the functional configuration of an image processing system 900. FIG. 9 illustrates an example of the functional configuration implemented based on the configuration of the image processing system 10 illustrated in FIG. 1A. In the functional configuration of FIG. 9, an edge detection unit 901 is added to the image processing system 10 illustrated in FIG. 1B. In the following description, content already described in relation to FIG. 1B will be omitted, and processing specific to the present embodiment will be mainly described.

The image acquisition unit 151 outputs image data to the edge detection unit 901 in addition to the focus level information calculation unit 152 and the recording processing unit 155. Haptics data is also input also from the haptics acquisition unit 153 to the edge detection unit 901.

The edge detection unit 901 performs edge detection processing on image data input from the image acquisition unit 151, and extracts edge information in which a steep change in the data is an edge. The edge detection processing is similarly performed also on haptics data input from the haptics acquisition unit 153, and extracts edge information in which a steep change in the data is an edge. The edge detection unit 901 outputs, to a haptics change unit 905, image edge information on the acquired image data and haptics edge information on the haptics data. The edge detection processing in the edge detection unit 901 can be performed, for example, by using a known technology such as a differential filter in the horizontal/vertical direction or a Sobel filter. However, the edge detection method is not limited to the above-described method, and may be implemented by other methods.

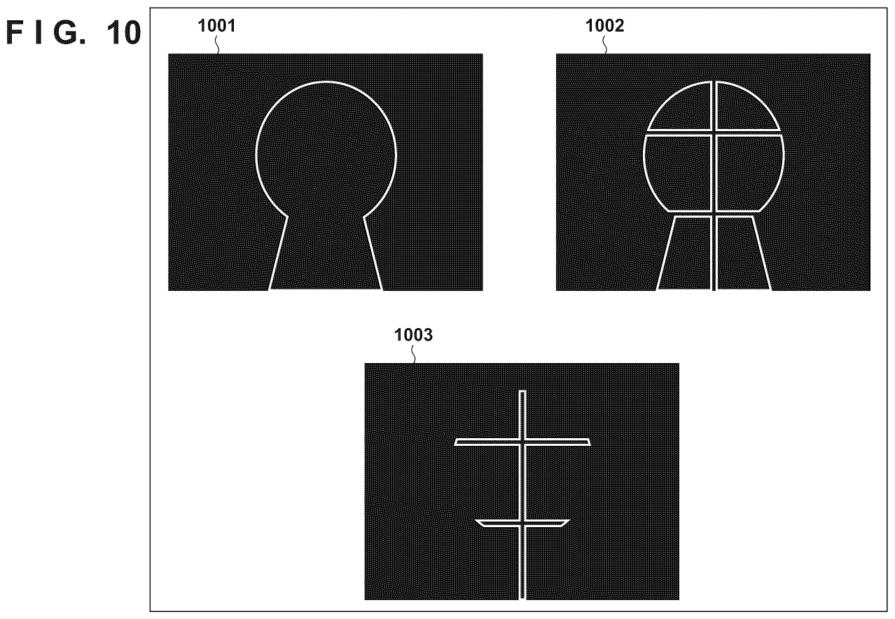

Here, an example in which the acquired edge information is visualized is illustrated in FIG. 10. Edge information 1001 indicates an edge detection result (image edge information) for the image data. Edge information 1002 indicates an edge detection result (haptics edge information) for the changed haptics data. Edge difference information 1003 is a difference between the edge information 1001 and the edge information 1002, and indicates a lacking region where data is lacking in the haptics data. As seen by comparing the edge information 1001 and 1002, when a lack occurs in haptics data, the edge detection result of the image data and the edge detection result of the haptics data do not match. That is, an information deviation occurs between the visual information and the haptics information. By performing edge detection in this manner, it is possible to determine whether there is a lack in the haptics data.

Returning to the description of FIG. 9, the haptics change unit 154 performs the first change processing by using the focus level information input from the focus level information calculation unit 152 and the haptics data input from the haptics acquisition unit 153. Thereafter, for the haptics data after the first change processing, the second change processing is performed using the edge information input from the edge detection unit 901. The haptics change unit 154 outputs the haptics after the change to the recording processing unit 155.

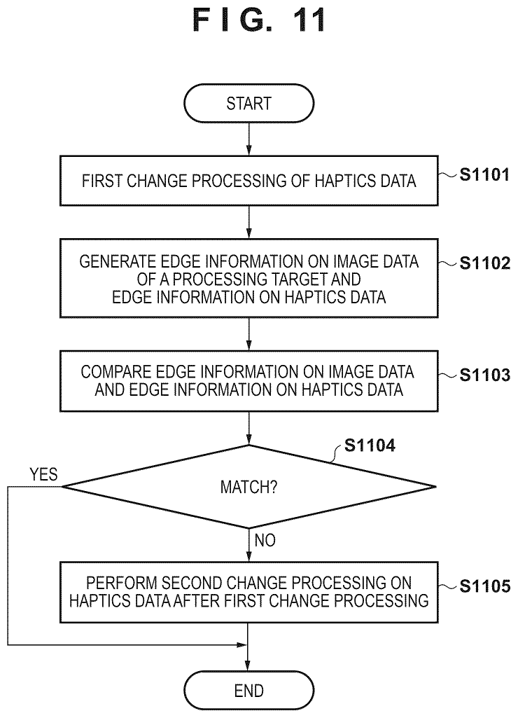

Hereinafter, the change processing of haptics data in the present embodiment will be described. FIG. 11 is a flowchart showing an example of processing corresponding to the present embodiment. The processing corresponding to the flowchart can be implemented, for example, when the CPU of the control unit 104 functioning as the haptics change unit 154, the edge detection unit 901, or the like executes corresponding programs (stored in the ROM or the like).

First, in S1101, change processing of haptics data (first change processing) is performed. The processing is similar to the processing described with reference to FIGS. 5 to 7 and the like in the first embodiment. The first change processing in S1101 may be performed concurrently the processing in and after S1102, or may be performed prior to the processing in S1102.

In S1102, the edge detection unit 901 acquires image data as the processing target from the image acquisition unit 151, and detects edge information on the image data. The corresponding haptics data is acquired from the haptics acquisition unit 153, and edge information on the haptics data is detected. In subsequent S1103, the haptics change unit 154 acquires image edge information and haptics edge information from the edge detection unit 901, and compares both of the edge information. Then, in S1104, it is determined whether or not they match. When a degree of matching of both of the edge information is less than a predetermined threshold, it is regarded that the both do not match, and the process proceeds to S1105. On the other hand, when the degree of matching is equal to or greater than the predetermined threshold, it is regarded that the both match, and the present processing ends. Note that when there is unprocessed haptics data, the processing of S1101 to S1105 are repeatedly executed.

In the comparison processing in S1103, as described with reference to FIG. 10, the difference of the edge information is taken, and the amount of information remaining as the difference information is determined, whereby it is possible to determine whether or not to match. Specifically, when the amount of difference information is less than a threshold, it can be determined to match, and when the amount of difference information is equal to or greater than the threshold, it can be determined to mismatch.

In S1105, the haptics change unit 154 performs, on the haptics data on which the first change processing is made in S1101, processing (second change processing) of specifying and interpolating a lacking region of the haptics data based on the difference information obtained in S1103. This can compensate haptics data for a part where the main subject 801 visually recognized in the image data is shielded by the subject 802 not visually recognized in the image data. The second change processing can be implemented by replacing or interpolating a lacking part of the haptics data based on the difference information with the maximum value, the minimum value, the mean value, the median, or the like of neighboring data of the haptics data. However, the interpolation method of haptics data is not limited to the above-described method, and may be implemented by other methods. Note that even if the deviation of an outline portion of the main subject 801 remains as a difference, the part can be regarded as subject information, and thus there is no problem if being left in the haptics data.

According to the present embodiment, it is possible to determine whether there is a lack due to a foreground or a front obstacle in haptics data by using a feature amount such as edge information, and perform interpolation processing in accordance with the determination result. Therefore, it is possible to solve the problem that the user is given a sense of incongruity because the existence of the foreground or the front obstacle not appearing in the image data remains in the haptics data. Due to this, also in the present embodiment, a change to haptics data in which an information deviation from visual information is suppressed is possible.

### Third Embodiment

In the first and second embodiments, the method of changing and recording haptics data by using calculated focus level information has been described. On the other hand, it is also possible to change the haptics data by holding the focus level information as attribute information or meta information without changing the haptics data at the time of recording, and reading the focus level information at the time of reproduction. In the present embodiment, a method of changing haptics data at the time of reproduction by using focus level information held in advance will be described. Description of content similar to that of the first and second embodiments will be omitted.

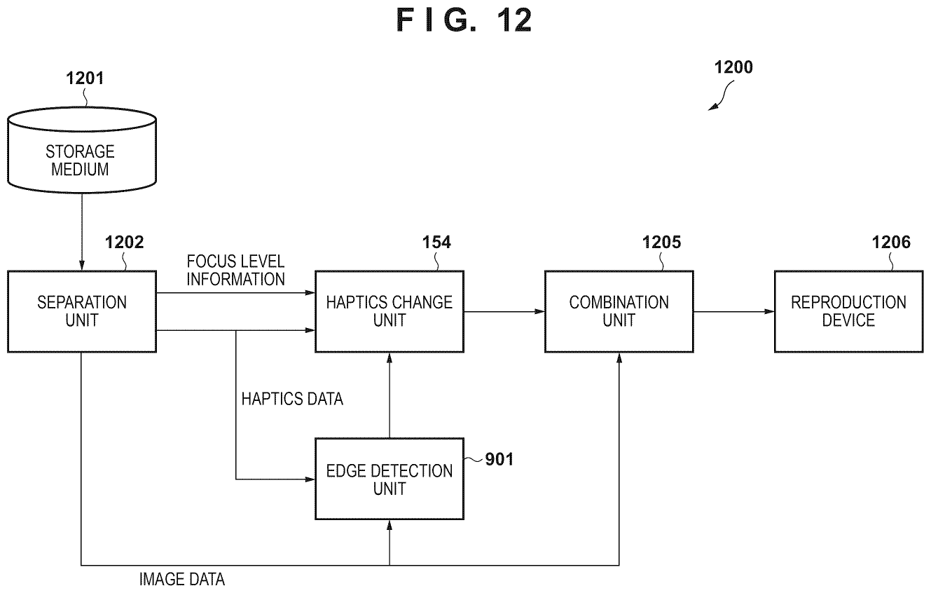

FIG. 12 illustrates the configuration of an image processing system of the third embodiment. FIG. 12 illustrates the functional configuration implemented based on the configuration of the image processing system 10 illustrated in FIG. 1A. In the functional configuration of FIG. 12, an image processing system 1200 includes a storage medium 1201, a separation unit 1202, the edge detection unit 901, the haptics change unit 154, a combination unit 1205, and a reproduction device 1206. For the haptics change unit 154 and the edge detection unit 901, the configurations described in the first and second embodiments are further added with a function corresponding to the present embodiment.

The storage medium 1201 holds an image file generated by associating image data with haptics data. The storage medium 1201 may be the storage unit 105 or an external storage medium (memory card or the like) mounted to the storage unit 105. The image file is also added with focus level information. The storage medium 1201 outputs an image file with haptics to the separation unit 1202 in response to a reproduction instruction from the user. The separation unit 1202 is implemented by the control unit 104, and separates the image file with haptics input from the storage medium 1201 into image data, haptics data, and focus level information. The separated haptics data is output to the edge detection unit 901 and the haptics change unit 154. The separated focus level information is output to the haptics change unit 154. The separated image data is output to the edge detection unit 901 and the combination unit 1205.

The edge detection unit 901 is implemented by the control unit 104, and detects edge information on the image data and the haptics data input from the separation unit 1202. The detected edge information is output to the haptics change unit 154. The haptics change unit 154 performs change processing (first change processing and second change processing) of changing haptics data by using the focus level information input from the separation unit 1202 and the edge information input from the edge detection unit 901. Haptics data change content and the change method are similar to the content described in the first embodiment and the second embodiment. Then, the changed haptics data is output to the combination unit 1205.

The combination unit 1205 is implemented by the control unit 104, and combines the image data input from the separation unit 1202 and the haptics data input from the haptics change unit 154, and generates an image file with haptics again. The reproduction device 1206 is implemented as the external output apparatus 120, and can display image data on the display, touch the display, and output a feedback of haptics data of a touch region of the display with a haptics device. In this manner, it is possible to perform feedback of haptics data in accordance with the display operation content from the user at the same time as reproducing the image data of the image file with haptics provided from the combination unit 1205.

As described above, by adding the focus level information to the image file with the haptics data and recording the image file in advance, it is possible to change the haptics with the sense of incongruity given to the user being reduced even at the time of reproduction.

### Fourth Embodiment

In the first to third embodiments, the method of changing the haptics data using the focus level information has been described. However, it is also assumed a case where the focus level information cannot be acquired because the haptics data is changed. In such a case, depth information such as a depth map can be used.

Recently, a depth map that is depth information on an image has been increasingly utilized in editing software. The depth map is metadata representing the depth by white and black density information, and is expressed as black toward the front and white toward the back, for example. When the depth map is utilized for editing, blurring can be added to an arbitrary depth. An increasing number of devices can record such depth maps.

In the depth map, an imaging object in a space is represented by density information, and the density represented by the density information represents the position of the imaging object. The information represented by the depth map has a meaning different from that of the information represented by the focus level information, but is common in that the information reflects the position of the imaging object in the space. Therefore, using depth information such as a depth map, it is possible to set the focus level in units of imaging objects, such as selecting an imaging object with a high degree of focus and a subject with a low degree of focus.

Therefore, in the present embodiment, a method will be described in which, when focus level information is not recorded, information having information in units of imaging objects such as a depth map is converted into focus level information, and haptics data is changed using this focus level information. Specifically, an in-focus area and an out-of-focus area are set using the depth map. This can be performed by designating a region for adding blurring at the time of editing using the depth map. A depth blurring function in general editing software adds blurring to a subject or a region having depth information designated by the user. That is, haptics information is changed for a region where depth blurring is performed by a user operation.

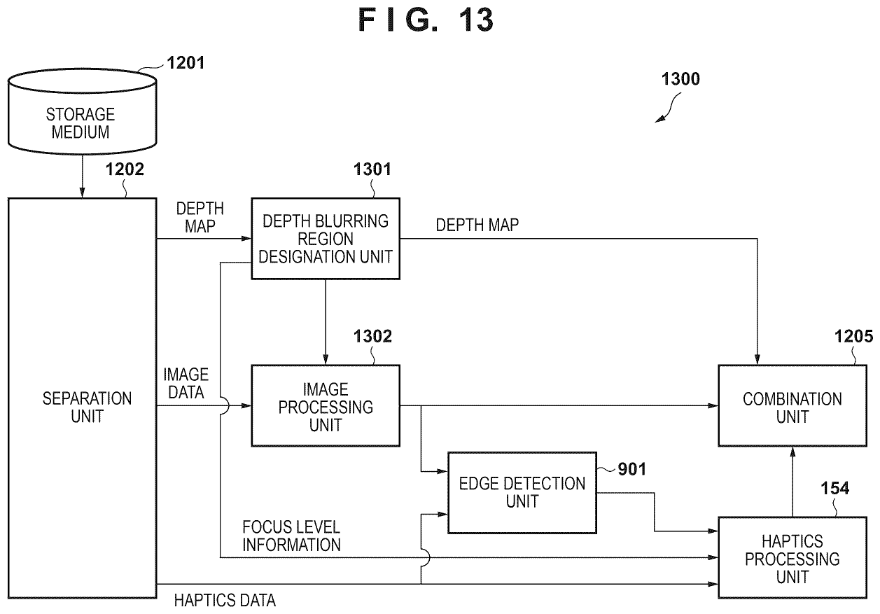

FIG. 13 illustrates a configuration example of an image processing system of the fourth embodiment. FIG. 13 illustrates an example of the functional configuration implemented based on the configuration of the image processing system 10 illustrated in FIG. 1A. In the functional configuration of FIG. 13, an image processing system 1300 includes the storage medium 1201, the separation unit 1202, a depth blurring region designation unit 1301, an image change unit 1302, the edge detection unit 901, the haptics change unit 154, and the combination unit 1205. The functional blocks described in the first to third embodiments are denoted by common reference numbers, and functions corresponding to the present embodiment are further added to the configurations described in the first to third embodiments.

The storage medium 1201 holds an image file added with haptics data. In the present embodiment, unlike the third embodiment, the image file further includes a depth map. The storage medium 1201 outputs an image file with haptics to the separation unit 1202 in response to a reproduction instruction and an editing instruction received from the user via the operation unit 107 of the imaging apparatus 100, for example. The depth map will be described later.

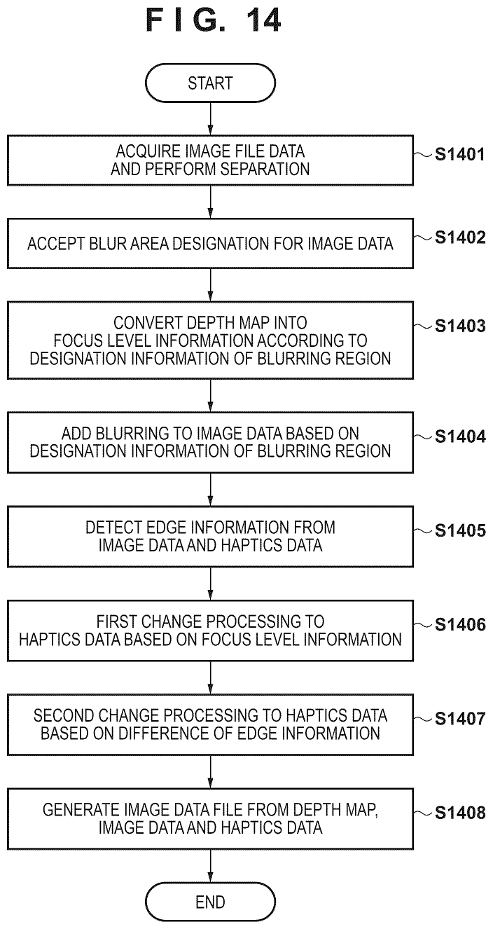

Hereinafter, the flow of processing in the image processing system 1300 will be described with reference to the flowchart of FIG. 14. The processing corresponding to the flowchart can be implemented by the CPU of the control unit 104 functioning as, for example, the separation unit 1202, the depth blurring region designation unit 1301, the image change unit 1302, the edge detection unit 901, the haptics change unit 154, and the combination unit 1205 executing corresponding programs (stored in the ROM or the like).

First, in S1401, the separation unit 1202 separates the image file with haptics input from the storage medium 1201 into image data, haptics data, and a depth map. The separated depth map is output to the depth blurring region designation unit 1301, the image data is output to the image change unit 1302, and the haptics data is output to the edge detection unit 901 and the haptics change unit 154.

In subsequent S1402, the depth blurring region designation unit 1301 implemented by the control unit 104 receives designation of a region added with blurring from the user, and outputs information (designation information) of the designation region such as coordinate information and mask data to the image change unit 1302. In subsequent step S1403, the depth map input from the separation unit 1202 is converted into focus level information. When converting the depth map into the focus level information, the depth blurring region designation unit 1301 generates the focus level information by setting the region not added with blurring as an in-focus area and setting the region added with blurring as an out-of-focus area based on the designation information in S1402. The generated focus level information is output to the haptics change unit 154. A conversion method into the focus level information will be described later. In order to reconstruct the image file with haptics, the depth map is output to the combination unit 1205.

In subsequent S1404, the image change unit 1302 is implemented by the control unit 104, and applies predetermined image processing and added blurring to the image input from the separation unit 1202 based on the designation information input from the depth blurring region designation unit 1301. Then, the image data applied with the image processing is output to the edge detection unit 901 and the combination unit 1205. In S1405, the edge detection unit 901 detects the edge information from the changed image data and the haptics data input from the image change unit 1302. The detected edge information is output to the haptics change unit 154.

In S1406, the haptics change unit 154 changes the haptics data input from the separation unit 1202 by using the focus level information input from the depth blurring region designation unit 1301 (first change processing). A change method of the haptics data will be described later. Then, the changed haptics data and depth map are output to the combination unit 1205. In S1407, by using the difference between the edge information detected from the image data and the haptics data, determination on presence or absence of a lack of haptics data and interpolation processing (second change processing) are performed. Since the second change processing of the haptics data using the edge information has been described in the second embodiment, the description is omitted in the present embodiment.

In S1408, the combination unit 1205 combines the depth map input from the depth blurring region designation unit 1301, the image data input from the image change unit 1302, and the haptics data input from the haptics change unit 154, and forms the image file with haptics again. Then, the image file with haptics is written in the storage medium 1201.

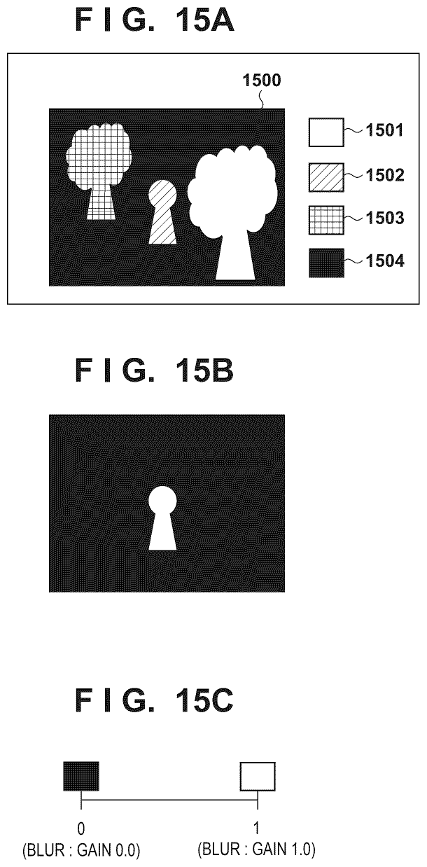

A configuration example of the depth map of the present embodiment will be described with reference to FIG. 15. FIG. 15 assumes that the acquired image data is similar to that of FIG. 3A, and the acquired haptics data is similar to that of FIG. 2B. An example of the acquired depth map is illustrated in FIG. 15A. In a depth map 1500, density coloring is performed in accordance with the depth level corresponding to the distance to the subject in the image data. The depth level associated with the subject 301 is 1502, the depth level associated with the subject 302 is 1501, the depth level associated with the subject 303 is 1503, and the depth level associated with the background 304 is 1504. The user can select a region added with blurring for each region applied with this density coloring.

Here, it is assumed that the user designates the region other than the depth level 1502 as a region added with blurring. The focus level information generated by the depth blurring region designation unit 1301 is illustrated in FIG. 15B. A data format is illustrated in FIG. 15C. FIG. 15C illustrates the focus level in 2 tones by 1 bit. A region of the focus level 0 indicates a region added with blurring, and a region of the focus level 1 indicates a region not added with blurring. An example is presented, in which the focus level information in 2 tones is assigned with a numerical value of 0.0 to 1.0 as a gain value to be used for conversion processing of haptics data described later. In the present embodiment, an example in which the focus level is expressed in 2 tones has been described, but the present invention is not limited to this tone number, and the focus level may be expressed by an any tone number.

Next, a change method of haptics data performed by the haptics change unit 154 will be described. The change method can be performed similarly to the method described in FIG. 7. FIG. 7 illustrates the haptics data 701 before change, the focus level information 702, and haptics data 703 after change. In the present embodiment, the focus level information 702 can be the focus level information obtained from the depth map as described above. Also in the present embodiment, the haptics data 701 and the focus level information 702 can be multiplied to obtain the haptics data 703. Here, the haptics data of a blurring region having the gain of 0.0 is changed to 0. This can suppress information deviation between the visual information and the haptics information, such as the presence of haptics in a blurring region.

In the present embodiment, the image change is performed so as to add blurring to the designation region, but the embodiment is not necessarily limited to this form, and only the processing of receiving designation of a region using the depth map and changing the haptics data by that is performed, and the image itself needs not be added with blurring.

According to the present embodiment, even if the focus level information is not held, it is possible to change haptics data by converting general-purpose meta information such as a depth map into focus level information. In the present embodiment, the method of changing the haptics data has been described with the depth map as an example, but other metadata that can set the focus level similarly to the depth map may be used, and the present invention is not limited to this.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-002791, filed on Jan. 11, 2024, which is hereby incorporated by reference herein in its entirety.

What is claimed is:

1. An image processing apparatus comprising:
one or more processors; and
a memory storing a program which, when executed by the one or more processors, causes the image capture apparatus to:
execute acquisition processing to acquire information on focus levels indicating degrees of focus of imaging objects included in image data to be processed, the information being obtained based on imaging information when image data as the processing target is acquired by imaging;
execute haptics change processing to make, based on the information on the focus levels, a first change on haptics data acquired in association with the image data as the processing target; and
execute generation processing to generate an image file by associating, with the image data as the processing target, the haptics data after the first change is performed,
wherein the first change includes changing values of the haptics data of at least some imaging objects among the imaging objects.

2. The image processing apparatus according to claim 1, wherein the first change includes a change made so as to attenuate the haptics data for other imaging objects except a predetermined imaging object among the imaging objects.

3. The image processing apparatus according to claim 1, wherein
the focus level includes at least a first focus level and a second focus level lower in degree of focus than the first focus level, and
the first change includes at least any of
a change made so as to attenuate a value of haptics data of an imaging object having the second focus level,
a change made so that a value of haptics data of an imaging object having the first focus level is larger than the value of the haptics data of the imaging object having the second focus level, and
a change made so as to make a degree of an increase in the value of the haptics data of the imaging object having the first focus level larger than a degree of an increase in the haptics data of the imaging object having the second focus level.

4. The image processing apparatus according to claim 3, wherein
the imaging information includes information indicating types of the imaging objects, and
in the haptics change processing, in a case where the imaging object having the second focus level has a predetermined type, a value of the haptics data after the first change for the imaging object increases more than a value of the haptics data after the first change in a case of not having the predetermined type.

5. The image processing apparatus according to claim 1, wherein the program, when executed by the one or more processors further causes the image processing apparatus to execute edge detection processing to extract edge information from the image data as the processing target and the haptics data, and
in the haptics change processing, a second change is made on the haptics data on which the first change is made, based on difference information between first edge information extracted from the image data as the processing target and second edge information extracted from the haptics data, and
the second change includes a change so as to interpolate a lacking region of a value in the haptics data corresponding to the difference information.

6. The image processing apparatus according to claim 5, wherein the lacking region corresponds to a part where an imaging object visually recognized in the image data as the processing target is shielded by another imaging object not visually recognized.

7. The image processing apparatus according to claim 1, wherein the acquisition processing includes a calculation processing to calculate the information on the focus level based on the imaging information.

8. The image processing apparatus according to claim 7, wherein
in the calculation processing:
a depth of field based on the imaging information is calculated; and
the focus level such that, among the imaging objects included in the image data, an imaging object included in an in-focus area has a first focus level, and an imaging object not included in the in-focus area has a second focus level is calculated, and
the in-focus area is set based on a distance to a predetermined imaging object and the depth of field.

9. The image processing apparatus according to claim 8, wherein the depth of field includes a front depth of field and a rear depth of field.

10. The image processing apparatus according to claim 7, wherein the imaging information includes a sensor diameter, an F number, and a focal length.

11. The image processing apparatus according to claim 1, wherein in the acquisition processing, the information on the focus level from a storage medium in which the image data as the processing target and the information on the focus level are stored in association with each other is acquired.

12. The image processing apparatus according to claim 1, wherein in the acquisition processing depth information from a storage medium in which the image data as the processing target and the depth information of the imaging object are stored in association with each other is read, and generates the information on the focus level from the depth information.

13. The image processing apparatus according to claim 12, wherein in the acquisition processing, the information on the focus level is generated from the depth information based on information on a designation region set for the depth information.

14. The image processing apparatus according to claim 13, wherein in the acquisition processing, the information on the focus level such that a region not added with blurring is higher in degree of focus than a region added with blurring is generated, based on the information on the designation region.

15. The image processing apparatus according to claim 13, wherein the program, when executed by the one or more processors further causes the image processing apparatus to execute an image change processing to make a change on the image data as the processing target by adding blurring to the designation region.

16. The image processing apparatus according to claim 1, wherein the haptics data includes at least any of temperature data and tactile data.

17. A control method of an image processing apparatus, the control method comprising:
acquiring information on focus levels indicating degrees of focus of imaging objects included in image data as a processing target, the information being obtained based on imaging information when image data as the processing target is acquired by imaging,
making, based on the information on the focus levels, a first change on haptics data acquired in association with the image data as the processing target, and
generating an image file by associating, with the image data as the processing target, the haptics data after the first change is performed,
wherein the first change includes changing values of the haptics data of at least some imaging objects among the imaging objects.

18. A non-transitory computer-readable storage medium storing one or more program including instructions that, when executed by a processor of an image processing apparatus, cause the image processing apparatus to perform:
acquiring information on focus levels indicating degrees of focus of imaging objects included in image data as a processing target, the information being obtained based on imaging information when image data as the processing target is acquired by imaging,
making, based on the information on the focus levels, a first change on haptics data acquired in association with the image data as the processing target, and
generating an image file by associating, with the image data as the processing target, the haptics data after the first change is performed,
wherein the first change includes changing values of the haptics data of at least some imaging objects among the imaging objects.
